(19) United States
(12) Patent Application Publication
(10) Pub. No.: US 2017/0332550 A1
(43) Pub. Date: Nov. 23, 2017

(54) Backside Idler Pulley

(71) Applicant: Briggs & Stratton Corporation, Wauwatosa, WI (US)

(72) Inventors: Richard K. Smith, JR., Morrisville, NY (US); Joshua R. Kowalski, Hamilton, NY (US)

(21) Appl. No.: 15/603,398

(22) Filed: May 23, 2017

Related U.S. Application Data
(60) Provisional application No. 62/340,506, filed on May 23, 2016.
(60) Provisional application No. 62/340,499, filed on May 23, 2016.

(51) Int. Cl. A01D 34/76; A01D 34/81; F16H 7/02; F16H 55/36

(52) U.S. Cl. CPC A01D 34/76; F16H 55/36; A01D 34/81; F16H 7/02; F16H 2055/363

(57) ABSTRACT

A backside idler pulley includes a first member forming a first side wall of a circumferential groove of the backside idler pulley and a second member, formed separately from the first member, and forming a second side wall, opposite the first side wall, of the circumferential groove of the backside idler pulley. The first member and the second member form first and second floor supports, respectively. The backside idler pulley further includes a continuous layer between the first side wall and the second side wall, the continuous layer being supported by the first and second floor supports while forming a floor of the groove.

### CROSS-REFERENCE TO RELATED PATENT APPLICATIONS

The present application claims priority under 35 USC 119 from co-pending U.S. Provisional Patent Application Ser. No. 62/340,506 filed on May 23, 2016 by Richard K. Smith and Joshua R. Kowalski and entitled BACKSIDE IDLER PULLEY, the full disclosure of which is hereby incorporated by reference. The present application claims priority under 35 USC 119 from co-pending U.S. Provisional Patent Application Ser. No. 62/340,499 filed on May 23, 2016 by Richard K. Smith and Joshua R. Kowalski and entitled BELT OSCILLATION REDUCTION SYSTEM, the full disclosure of which is hereby incorporated by reference.

### BACKGROUND

Idler pulleys are frequently utilized in belt drive systems to guide and direct travel of a belt. Such idler pulleys do not drive other structures nor do they impart torque to the engaged belt. Backside idler pulleys engage the back or flat side of a belt. Many existing backside idler pulleys may cause accelerated wear of the belt, reducing the life of the belt.

### BRIEF DESCRIPTION OF THE DRAWINGS

FIG. 1 is a front view of an example backside idler pulley.

FIG. 2 is a side view of the backside idler pulley of FIG. 1.

FIG. 3 is a sectional view of the backside idler pulley of FIG. 1 taken along line 3-3.

FIG. 4 is an enlarged fragmentary view of a portion of the backside idler pulley shown in FIG. 3.

FIG. 5 is a perspective view of an example continuous layer for use in the pulley of FIG. 1.

FIG. 6 is a perspective view of another example continuous layer for use in the pulley of FIG. 1.

FIG. 7 is a sectional view of another example backside idler pulley.

FIG. 8 is an enlarged fragmentary view of a portion of the backside idler pulley shown in FIG. 7.

FIG. 9 is a sectional view of another example backside idler pulley.

FIG. 10 is an enlarged fragmentary view of a portion of the backside idler pulley shown in FIG. 9.

FIG. 11 is a sectional view of another example backside idler pulley.

FIG. 12 is an enlarged fragmentary view of a portion of the backside idler pulley shown in FIG. 11.

FIG. 13 is a sectional view of another example backside idler pulley.

FIG. 14 is an enlarged fragmentary view of a portion of the backside idler pulley shown in FIG. 13.

FIG. 15 is a sectional view of another example backside idler pulley.

FIG. 16 is an enlarged fragmentary view of a portion of the backside idler pulley shown in FIG. 15.

FIG. 17 is an enlarged fragmentary sectional view of another example backside idler pulley.

FIG. 18 is enlarged fragmentary sectional view of another example backside idler pulley being assembled.

FIG. 19 is an enlarged fragmentary sectional view of the assembled backside idler pulley of FIG. 18.

FIG. 20 is a flow diagram of an example method for forming a backside idler pulley.

FIG. 21 is a front perspective view of an example mower.

FIG. 22 is a front perspective view of an example mower deck and pulley arrangement of the mower of FIG. 21.

### DETAILED DESCRIPTION OF EXAMPLES

FIGS. 1-4 illustrate an example backside idler pulley 20. Backside idler pulley 20 may be utilized in belt drive systems to guide and direct travel of a belt. In such belt drive systems, backside idler pulley 20 does not drive other structures nor do they impart torque to the engaged belt. As will be described hereafter, backside idler pulley 20 comprises a cost-effective idler pulley that provides continuous, uninterrupted and substantially flat underlying support for the backside of a belt to reduce wear of the belt and prolong life of the belt.

As shown by FIGS. 1 and 2, pulley 20 comprises a wheel or disc at least partially about which a belt may be wrapped and guided. Pulley 20 is configured to be rotatable about an axis 24. Pulley 20 comprises a circumferential groove 22 comprising side walls 26A, 26B (collectively referred to as sidewalls 26) and a circumferential floor 28. Sidewalls 26 assist in maintaining a received belt against floor 28.

As shown by FIGS. 3 and 4, in one implementation, pulley 20 comprises members 34A, 34B (collectively referred to as member 34) and continuous layer 38. Members 34 comprise separately formed members, distinct physical structures joined to one another and extending opposite to one another so as to form groove 22. In the example illustrated, members 34A and 34B comprise side plates 40A, 40B and floor supports 42A, 42B, respectively. In the example illustrated, members 34 may be joined to one another by a cylindrical bushing 43 interconnecting side plates 40A, 40B and providing rotational axis 24. In other implementations, members 34 may alternatively be connected or joined to one another by other structures, such as fasteners or interlocking structures, extending between members 34. In yet other implementations, member 34 may be connected or joined to one another by floor supports 42, themselves, which are fastened, hooked, snapped, bonded or welded to one another.

Side plates 40A, 40B (collectively referred to as plates 40) comprise plates that extend opposite one another at spaced locations, wherein inner opposing faces of plates 40 form sidewalls 26. In the example illustrated, plates 40 extends substantially parallel to one another and perpendicular to axis 24. In other implementations, side plates 40 may extend non-parallel to one another and oblique to axis 24. Side plates 40 are connected to one another and spaced from one another by a distance greater than a maximum width of belt 53. Side plates 40 are spaced from one another such that side sidewalls 26 do not contact the front side 55 of belt 53, contacting neither front edges 57 or front face 59 of belt 53.

Floor supports 42A, 42B (collectively referred to as floor supports 42) comprise structures axially projecting from such inner opposing faces the plates 40 towards one another for the support of floor 28 of groove 22. Floor supports 42 are radially spaced from the outer perimeters 44 of plates 40, towards axis 24, to contribute to the depth of groove 22. In one implementation, floor supports 42 each comprise an annular ring continuously extending about axis 24 and underlying continuous layer 38. In another implementation, floor supports 42 each comprise a plurality of projections, tabs or other structures which project towards one another from the inner opposing faces of plates 40 and which are circumferentially spaced about axis 24.

In the example illustrated in FIGS. 3 and 4, and as best shown in FIG. 4, floor supports 42 project into contact or abutment with one another, the junction of floor supports 42 forming a seam 50. Seam 50 comprises a circumferential gap or cavity along the radial outer surface of floor supports 42. Absent continuous layer 38, seam 50 may result in an uneven surface profile that contacts the backside 61 of belt 53 and that may accelerate wear of belt 53.

Continuous layer 38 comprises an uninterrupted thickness of material extending between sidewalls 26. Continuous layer 38 has an outward face which provides floor 28 which contacts and abuts the backside 61 of belt 53. In the example illustrated, continuous layer 38 spans, extends across and covers seam 50. As a result, floor 28 of groove 22 is also continuous, uniformly flat and uninterrupted, prolonging the life of belt 53.

In one implementation, continuous layer 38 comprises a metal material. In another implementation, continuous layer 38 comprises polymer. In some implementations, continuous layer 38 comprises a rubber-like or elastomeric material.

FIG. 5 illustrates continuous layer 138, one example of continuous layer 38, prior to being applied over floor supports 42 between sidewalls 26 to form floor 28 of groove 22. Continuous layer 138 comprises an elongate strap or band of material having sufficient flexibility or bendability so as to be wrapped over floor supports 42 between sidewalls 26. In one implementation, continuous layer 138 has a length L equal to or greater than the circumference of floor 28 of grooves 22. In one implementation continuous layer 138 has a width W equal to or greater than at least 50% of the spacing between sidewalls 26. In one implementation, layer 138 has a width W of at least 90% of the spacing between sidewalls 26.

In one implementation, layer 138 is wrapped about and on top of supports 42 after members 34 have been joined to one another. In another implementation, layer 138 is wrapped about and on top of at least one of supports 42 prior to members 34 being joined to one another. In one implementation, layer 138 comprises a band of a metal material. In yet another implementation, layer 138 comprises a band of a polymeric or rubber-like material. In some implementations, face 141, opposite to the face 143 which forms floor 28, is at least partially coated with an adhesive material 145 (shown in broken lines) which further facilitates securement of layer 138 over and on top of supports 42. In other implementations, adhesive 145 may be omitted.

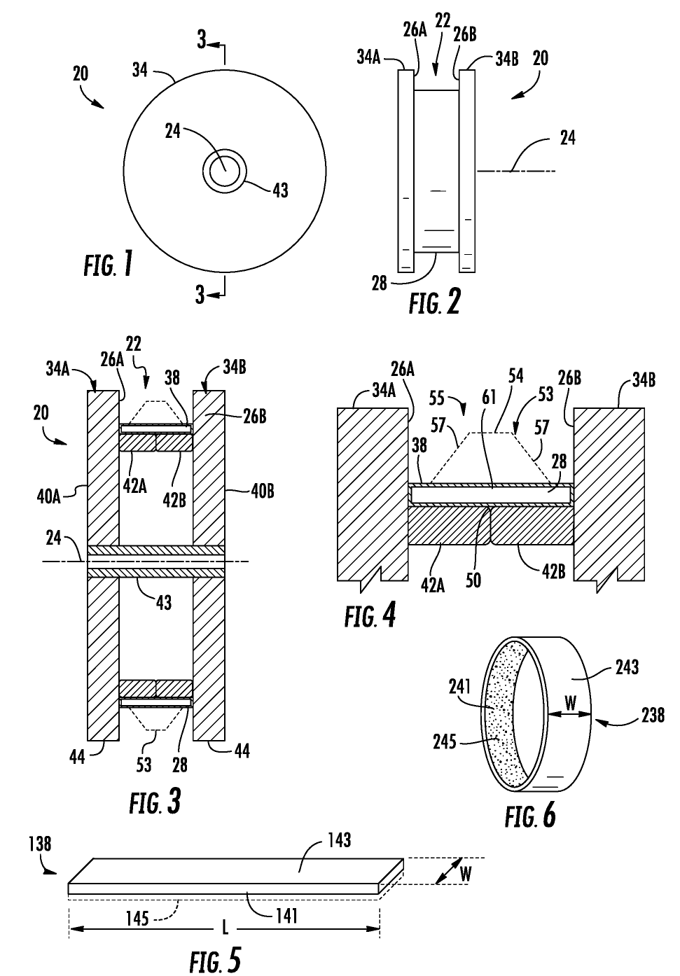

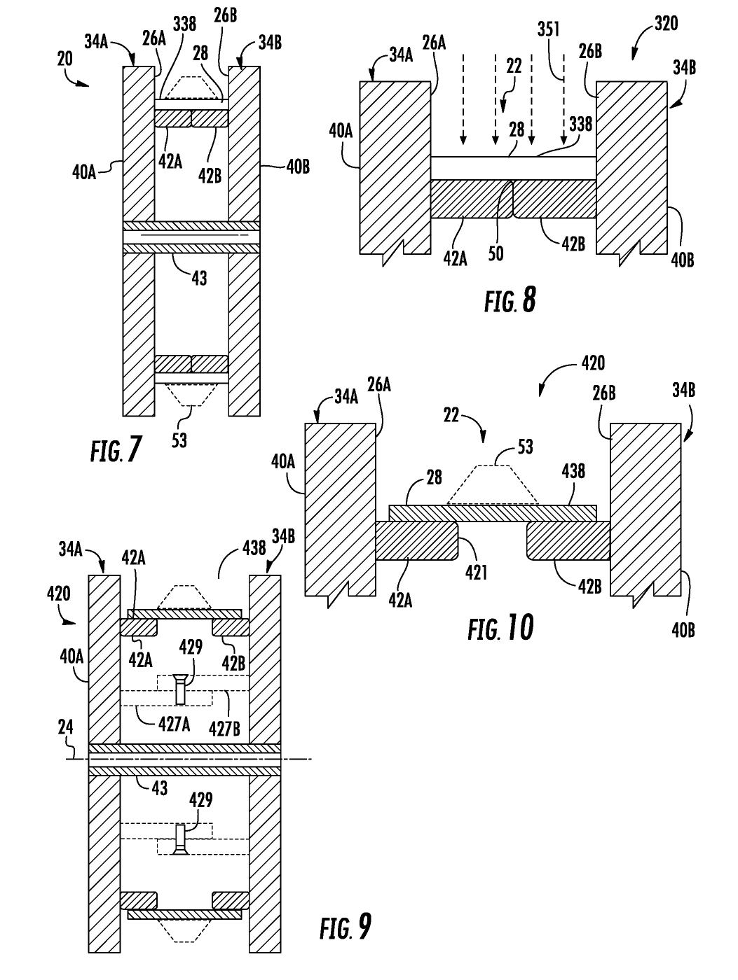

FIG. 6 illustrates continuous layer 238, another example of continuous layer 38, prior to being applied over floor supports 42 between sidewalls 26. Continuous layer 238 comprises an endless belt having an inner face 241 and an outer face 243, wherein face 241 is to contact the outer surface of floor supports 42 while outer face 243 forms floor 28 of groove 22. In the example illustrated, continuous layer 238 has an inner diameter less than the outer diameter of the outer circumference defined by floor supports 42 between sidewalls 26. In one implementation, the endless belt forming continuous layer 238 is sufficiently elastic such that the belt may be stretched over one of plates 40 into groove 22, wherein the belt stretches about and grips the outer surface of floor supports 42. In yet another implementation, the endless belt forming continuous layer 248 is sufficiently elastic such that although the belt may not be stretched over one of plates 42, the belt stretches about and grips the outer surface of at least one of floor supports 42 prior to members 34 being completely joined or connected to one another. In such an implementation, the belt is stretched about one of members 34, wherein pulley 20 is subsequently completed with the other of members 34.

In one implementation continuous layer 138 has a width W equal to or greater than at least 50% of the spacing between sidewalls 26. In one implementation, layer 138 has a width W of at least 90% of the spacing between sidewalls 26. In some implementations, face 241 is at least partially coated with an adhesive material 245 which further facilitates securement of layer 238 over and on top of supports 42. In other implementations, adhesive 245 may be omitted.

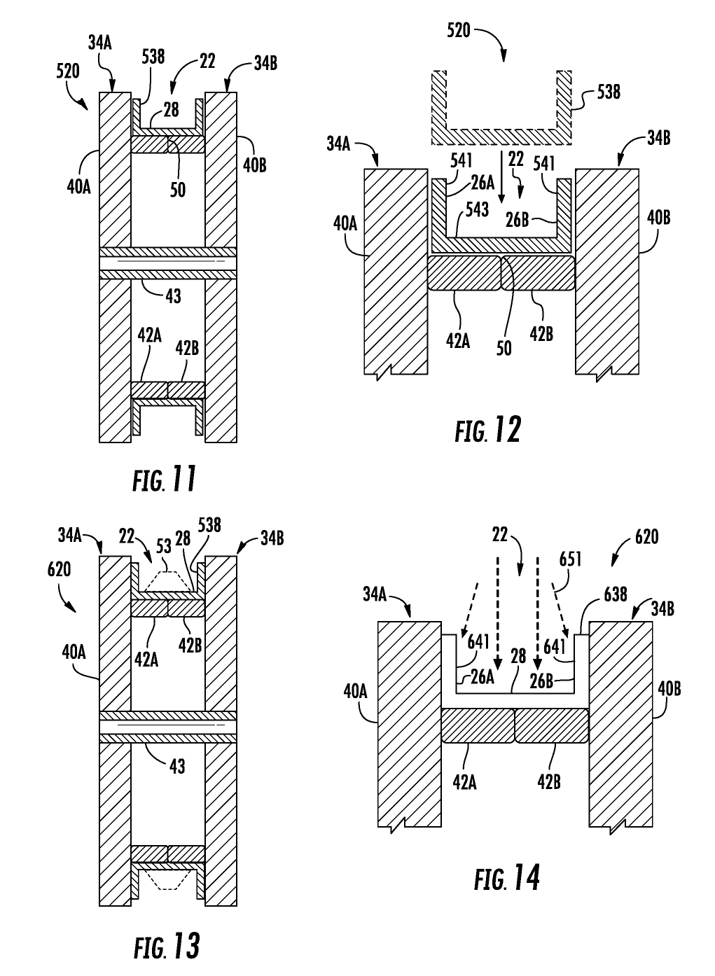

FIGS. 7 and 8 are sectional views illustrating backside idler pulley 320, an example implementation of pulley 20. Pulley 320 is similar to pulley 20 described above except that pulley 320 comprises continuous layer 338 in place of layer 38. Those remaining components of pulley 320 which correspond to components of 20 are numbered similarly.

Continuous layer 338, like layer 38, is located between sidewalls 26 and forms the floor 28 of groove 22. Layer 338 comprises a coating or film deposited upon the outer surface of floor supports 42. In one implementation, the coating or film forming layer 338 is deposited by being sprayed, dripped, poured or brushed on to the outer surfaces of foot supports 42 (as indicated by arrows 351). In one implementation, the coating or film is deposited in a liquid form and subsequently dried or cured. In another implementation, the coating or film is deposited as spray particles which adhere to one another (similar to spray paint) and which are layered upon one another over foot supports 42. The thickness of the coating or film is sufficient so as to fill in the recess or cavity of seam 50 and form a substantially level uninterrupted floor 28 for groove 22.

In one implementation, layer 338 comprises a metal film or coating. In another implementation, layer 338 comprises the polymeric film or coating in some implementations, layer 338 comprises a film or coating of an elastic rubber-like material.

In some implementations, the coating or film may fill in and cover-up other cavities on the upper outer surfaces of foot supports 42. In some implementations, as will be described hereafter, foot supports 42 may be welded to one another or bonded to one another, forming mounds or protuberances rising above foot supports 42, wherein the coating or film has a thickness greater than the height of the protuberance and covers the weld, adhesive bead or any protuberances along the upper outer surface of foot supports 42. As a result, the top surface of layer 338 is substantially level or flat as it extends completely across the juncture of foot supports 42.

FIGS. 9 and 10 are sectional views illustrating backside idler pulley 420, an example implementation of pulley 20. Pulley 420 is similar to pulley 20 described above except when members 34 are connected, floor supports 42 are axially spaced from one another, spaced apart and separated from one another in directions along axis 24 to form a gap 421. Pulley 420 further comprises continuous layer 438 in lieu of continuous layer 38.

Continuous layer 438 is similar to continuous layer 38 described above except that continuous layer 438 possesses sufficient rigidity or strength so as to bridge across gap 421 and maintain its shape across gap 421 despite the forces exerted against layer 438 during use of pulley 420. In one implementation, continuous layer 438 comprises a metal layer. In another implementation, layer 438 comprises a polymeric layer. In one implementation, layer 438 comprises a band, similar to layer 138 described above, wherein layer 438 is wrapped about foot supports 42. In another implementation, layer 438 comprises an annular ring positioned about foot supports 42. In one implementation, layer 438 is positioned over one of foot supports 42 prior to the two members 34 being connected to one another.

In the example illustrated, bushing 43 connects members 34. In some implementations, member 34 may be additionally or alternatively connected to one another by other connection mechanisms. For example, as indicated by broken lines, in one implementation, member 34A may additionally comprise connector 427A and member 34B may additionally comprise connector 427B, wherein connectors 427A and 427B are connected to one another to join members 34 to one another in the spaced apart relationship. In the example illustrated, connectors 427A and 427B comprise overlapping rings or cylinders, wherein one ring or cylinder receives the other ring or cylinder. In the example illustrated, the overlapping rings or cylinders forming connectors 427A and 427B are secured to one another by fasteners 429. In other implementations, the overlapping rings or cylinders may be secured to one another by welds, adhesives, mechanical interlocking features or a press-fit relationship. In other implementations, connectors 427A and 427B may alternatively comprise overlapping tabs or fingers extending from the respective plates 40A and 40B. In yet other implementations, member 34 may be connected to one another by other mechanisms.

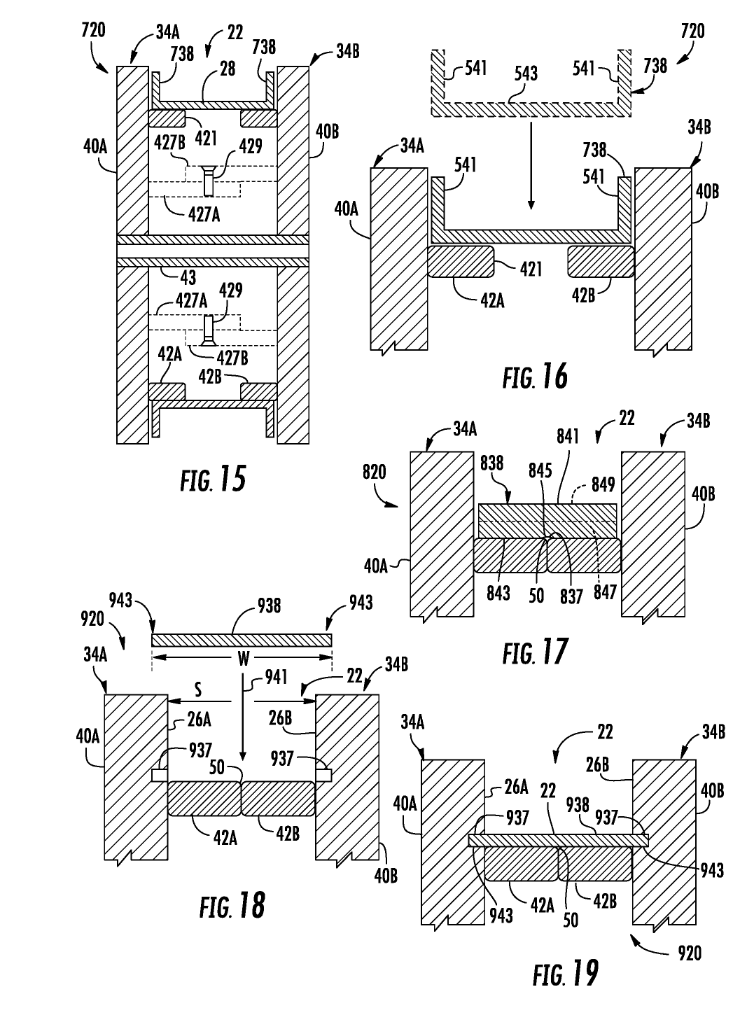

FIGS. 11 and 12 are sectional views illustrating backside idler pulley 520, an example implementation of pulley 20. Pulley 520 is similar to pulley 20 described above except that pulley 520 comprises continuous layer 538 in lieu of continuous layer 38. Those remaining structures or components of pulley 520 which correspond to components of pulley 20 are described above.

Continuous layer 538 is similar to continuous layer 38 except that continuous layer 538 additionally comprises sidewalls 541. Sidewalls 541 rise up from base panel 543 and overlap the opposing portions of the side plates 40, forming sides 26 of groove 22. In one implementation, continuous layer 538 is formed as an elongate drip or band, similar to continuous layer 138 described above, but additionally including the aforementioned sidewalls 541. In such an implementation, the continuous layer 538 wraps about floor supports 42. In another implementation, continuous layer 538 is similar to continuous layer 238 described above, formed as an endless belt which is stretched over one of the side plates 40 or which is positioned against one of side plates 40 prior to the connection of the other of side plates 40.

FIGS. 13 and 14 are sectional views illustrating backside idler pulley 620, an example implementation of pulley 20. Pulley 620 is similar to pulley 520 described above except that pulley 620 comprises continuous layer 638 in lieu of continuous layer 538. Those remaining structures or components of pulley 620 which correspond to components of pulley 20 or pulley 520 are described above.

Continuous layer 638 is similar to continuous layer 338 described above except that continuous layer 638 additionally comprises sidewalls 641. Sidewalls 641 coat the internal opposing sides of side plates 40 and form sidewalls 26 of circumferential groove 22. In one implementation, the coating or film forming layer 638 is deposited by being sprayed, dripped, poured or brushed on to the outer surfaces of side plates 40 and foot supports 42 (as indicated by arrows 651). In one implementation, the coating or film is deposited in a liquid form and subsequently dried or cured. In another implementation, the coating or film is deposited as spray particles which adhere to one another (similar to spray paint) and which are layered upon one another over side plates 40 and foot supports 42. The thickness of the coating or film is sufficient so as to fill in the recess or cavity of seam 50 and form a substantially level uninterrupted floor 28 for groove 22.

In one implementation, layer 638 comprises a metal film or coating. In another implementation, layer 638 comprises the polymeric film or coating in some implementations, layer 638 comprises a film coating of an elastic rubber-like material.

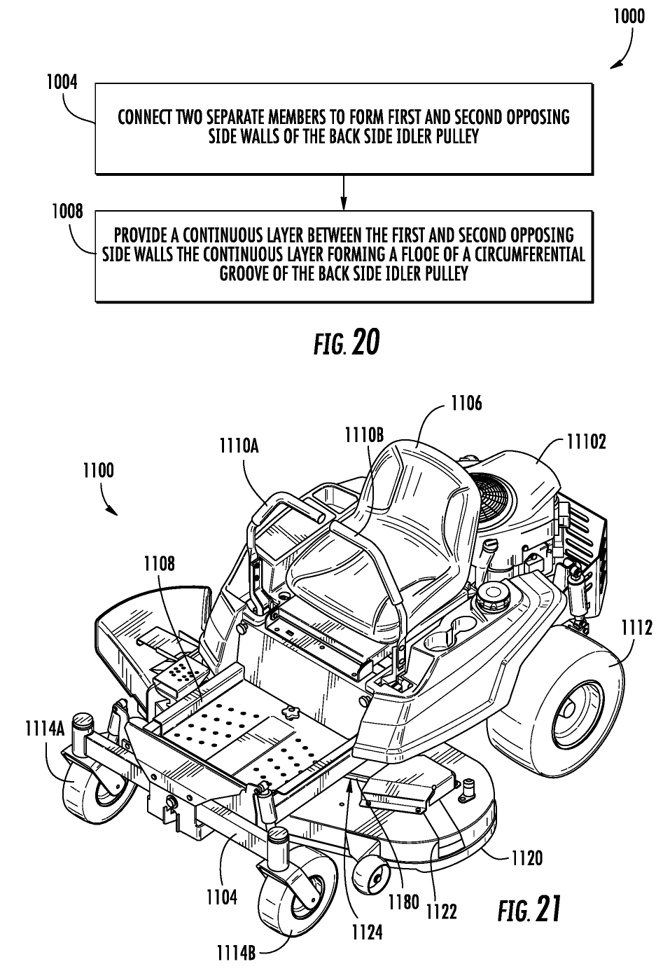

FIGS. 15 and 16 are sectional views illustrating backside idler pulley 720, an example implementation of pulley 20. Pulley 720 is similar to pulley 420 described above except that pulley 720 comprises continuous layer 738 in lieu of continuous layer 438.

Continuous layer 738 is similar to continuous layer 538 described above except that continuous layer 738 possesses sufficient rigidity or strength so as to bridge across gap 421 and maintain its shape across gap 421 despite the forces exerted against layer 738 during use of pulley 720. In one implementation, continuous layer 738 comprises a metal layer. In another implementation, layer 738 comprises a polymeric layer. In one implementation, layer 738 comprises a band, similar to layer 138 described above, wherein layer 738 is wrapped about foot supports 42. In another implementation, layer 738 comprises an annular ring positioned about foot supports 42. In one implementation, layer 738 is positioned over one of foot supports 42 prior to the two members 34 being connected to one another.

FIG. 17 is a sectional view of a portion of backside idler pulley 820, another example implementation of backside idler 20. Backside idler 820 is similar backside idler 20 described above except a backside idler 820 additionally comprises protuberance 837 and comprises continuous layer 838 in place of layer 38. Those remaining structures or components of backside idler 820 which correspond to structures or components of backside idler 20 are numbered similarly or are shown in FIGS. 1-4.

Protuberance 837 comprises a raised portion radially projecting above the upper outer surfaces of floor supports 42. In one implementation, protuberance 837 comprises a weld bead or an adhesive bead at least partially filling seam 50 and rising above seam 50 at a junction of foot supports 42A and 42B. In other implementations, protuberance 837 comprises other surface irregularities or bumps on the upper outer surfaces of foot supports 42. Such protuberances, in the absence of continuous layer 838, might otherwise present surface irregularities that accelerate wear of a belt, such as belt 53 illustrated above.

Continuous layer 838 comprises a layer of material comprises an uninterrupted thickness of material extending between sidewalls 26. Continuous layer 838 has a uniformly flat outward face 841 (lacking bumps or protuberances) which provides floor 28 which contacts and abuts the backside 61 of belt 53. As a result, floor 28 of groove 22 is also continuous and uninterrupted, prolonging the life of belt 53. Continuous layer 838 has an inner face 843 that spans, extends across and covers protuberance 837.

In one implementation, inner face 843 has a preformed recess, notch or cavity 845 that has corresponding dimensions equal to or larger than that of protuberance 837 and which is located so as to receive protuberance 837 when layer 838 is positioned about foot supports 42. In another implementation, continuous layer 838 is formed from a sufficiently soft or compressible material such that the material adjacent those portions of inner face 843 that contact protuberance 837 are compressed, allowing inner face 843 to change shape to receive protuberance 837, wherein outer face 841 remains unchanged, being substantially uniformly flat across its surface between sidewalls 26 of groove 22. For example, if layer 838 may be stretched about foot supports 42, wherein portions of the underside of continuous layer 838 are compressed by protuberance 837 which is received by continuous layer 838.

In yet another implementation, as indicated by broken lines, continuous layer 838 may comprise multiple layers such as inner sublayer 847 and outer sublayer 849. In such an implementation, inner sublayer 847 may be formed from a sufficiently soft or compressible material such that the material adjacent those portions of inner face 843 that contact protuberance 837 are compressed, allowing inner face 843 to change shape to receive protuberance 837. Outer sublayer 849 may be formed from a different material than the material forming inner sublayer 847 that is less soft or less compressible as sublayer 847 such that outer sublayer 849 maintains its shape and uniformly flat outer face 841 despite the compression and deformation of sublayer 847. For example, in one implementation, sublayer 847 may comprise a compressible foam portion while sublayer 849 comprises a solid metal or polymer panel.

In one implementation, continuous layer 838 comprises a metal material. In another implementation, continuous layer 838 comprises polymer. In some implementations, continuous layer 838 comprises a rubber-like or elastomeric material. In yet other implementations, continuous layer 838 may comprise a combination of different materials. For example, in one implementation, sublayer 847 may comprise a compressible rubber material or polymeric foam while sublayer 849 comprises a metal material.

In one implementation, continuous layer 838 comprises an elongate strap or band of material, similar to continuous layer 138 described above, having sufficient flexibility or bendability so as to be wrapped over floor supports 42 between sidewalls 26. In one implementation, continuous layer 838 has a length L equal to or greater than the circumference of floor 28 of grooves 22. In one implementation continuous layer 838 has a width W equal to or greater than at least 50% of the spacing between sidewalls 26. In one implementation, layer 838 has a width W of at least 90% of the spacing between sidewalls 26.

In one implementation, layer 838 is wrapped about and on top of supports 42 after members 34 have been joined to one another. In another implementation, layer 838 is wrapped about and on top of at least one of supports 42 prior to members 34 being joined to one another.

In yet another implementation, continuous layer 838 comprises an endless belt, similar to continuous layer 238 described above. In such an implementation, continuous layer 838 may have an inner diameter less than the outer diameter of the outer circumference defined by floor supports 42 between sidewalls 26. In one implementation, the endless belt forming continuous layer 838 is sufficiently elastic such that the belt may be stretched over one of plates 40 into groove 28, wherein the belt stretches about and grips the outer surface of floor supports 42. In yet another implementation, the endless belt forming continuous layer 838 is sufficiently elastic such that although the belt may not be stretched over one of plates 40, the belt stretches about and grips the outer surface of at least one of floor supports 42 prior to members 34 being completely joined are connected to one another. In such an implementation, the belt is stretched about one of member 34, wherein pulley 20 is subsequently completed with the other of members 34.

In one implementation continuous layer 838 has a width W equal to or greater than at least 50% of the spacing between sidewalls 26. In one implementation, layer 838 has a width W of at least 90% of the spacing between sidewalls 26. In some implementations, face 843 is at least partially coated with an adhesive material which further facilitates securement of layer 838 over and on top of supports 42. In other implementations, the adhesive may be omitted.

FIGS. 18 and 19 are sectional views of a portion of backside idler pulley 920, another example implementation of backside idler 20. Backside idler 920 is similar backside idler 20 described above except a backside idler 920 additionally comprises retention grooves 937 and comprises continuous layer 938 in place of layer 38. Those remaining structures or components of backside idler 920 which correspond to structures or components of backside idler 20 are numbered similarly or are shown in FIGS. 1-4.

Retention grooves 937 comprise annular channels, slots, notches or recesses provided in the inner surfaces of side plates 40. Retention grooves encircle foot supports 42 and that extend in close proximity to and just above (or radially outside of) foot supports 42. Retention grooves 937 receive edge portions of continuous layer 938 to assist in locating and retaining layer 938 in place.

Retaining layer 938 is similar to retaining layer 38 described above except that retaining layer 938 is sized to completely extend across and completely span groove 22 while projecting into each of retention grooves 937. Retaining layer 938 has a width W greater than the spacing S between sidewalls 26 of grooves 22, but less than the outer widths of retention grooves 937. As with retaining layer 38, retaining layer 938 provides a smooth, substantially flat surface for floor 28 between sidewalls 26.

As indicated by arrow 941 in FIG. 18, in one implementation, retaining layer 938 is inserted into groove 22 after members 34 have been joined to one another. In such an implementation, continuous layer 938 is formed from a sufficiently flexible material or has opposite side edge portions 943 that are sufficiently flexible such that layer 938 may sufficiently bend to allow layer 938 to fit between sidewalls 26 and to be pushed towards floor supports 42 until such edge portions 943 resiliently snap or pop into retention grooves 937 to the retained position shown in FIG. 19. In yet other implementations, continuous layer 938 is inserted into one of retention grooves 937 of one of members 34 prior to connection of the other of members 34.

Although backside idler pulley 920 is illustrated as comprising continuous layer 938, in other implementations, backside idler pulley 920 may comprise other continuous layers. For example, in other implementations, pulley 920 may alternatively comprise layer 338 or layer 638 described above, wherein the coating or film forming such layers at least partially fills retention grooves 937 and wherein upon curing or solidification of such layers, retention grooves 937 assist in retaining such layers in place. In yet other implementations, pulley 920 may alternatively comprise layers 538 or 838 described above, wherein such layers include outer circumferential tabs that are received within retention grooves 937. In some implementations, members 34 may be axially spaced from one another, similar to the spacing shown in FIG. 9-10 or 15-16, wherein continuous layer 938 is similar to continuous layers 438, 738 in that continuous layer 938 is sufficiently rigid to bridge across the intervening gap between the foot supports of the members.

FIG. 20 is a flow diagram of an example method 1000 for forming a backside idler pulley, such as any of the backside idler pulleys described above. As indicated by block 1004, two separate members, such as member 34, are connected to form first and second opposing sidewalls, such as sidewalls 26, of a backside idler pulley. In one implementation, the two members abut one another along a circumferential seam 50 in the circumferential groove of the pulley. In another implementation, the two members are axially spaced from another along the groove with a gap therebetween.

As indicated by block 1008, a continuous layer is provided between the first second opposing sidewalls, wherein the continuous layer forms a floor of the circumferential groove of the backside idler pulley. The continuous layer provides a substantially smooth in uniform surface against which the backside of the belt contacts. The continuous layer reduces wear of the belt to prolong the useful life of the belt.

In one implementation, the continuous layer comprises a band wrapped about foot supports of the two members. In one implementation, the continuous layer comprises an endless belt. In one implementation, the continuous layer is formed by spraying or otherwise coating floor supports of the two members. In one implementation, the continuous layer forms a bridge between a gap between the two members along the circumferential groove of the idler pulley. In one implementation, the continuous layer has a U-shaped cross-section. In one implementation, the continuous layer is retained by retention grooves in the two members. In one implementation, the continuous layer covers and/or conforms to protuberances, such as weld or adhesive beads.

FIG. 21 illustrates an example machine, shown as a zero turn radius (ZTR) lawnmower 1100 which incorporates one or more of backside idler pulleys of the present disclosure. ZTR mower 1100 of FIG. 21 comprises a prime mover 1102, such as an air-cooled internal combustion engine, electric motor, etc., wherein prime mover 1102 is supported on a chassis 1104. An operator seat 1106 is coupled to chassis 1104 forward of prime mover 1102, enabling an operator to control ZTR lawnmower 1100 while seated in seat 1106 and having their feet placed on footplate 1108. Two control levers 1110A, 1110B are configured to be pivotally actuated by the operator to enable forward movement, reverse movement, and turning of ZTR lawnmower 1100, as is well known in the art. Control levers 1110A, 1110B are coupled to respective hydrostatic transaxles (not shown) to power respective right and left drive wheels 1112. In lieu of hydrostatic transaxles, drive via independent pump and wheel motors or independent electric drive motors is also possible. Additionally, it is possible for a single transmission (hydraulic or otherwise) to drive both right and left drive wheels 1112. Two front caster wheels 1114A, 1114B allow the mower be easily maneuvered in a zero turn radius fashion.

As further shown by FIG. 21, mower 1100 further comprises a mower deck assembly is hung from chassis 1104, wherein the mower deck assembly 1120 comprises one or more mowing blades 1122 powered by prime mover 1102 via a pulley arrangement 1124. Pulley arrangement 1124 utilizes a belt 1180 transmits power from prime mover 1102. Belt 1126 may be guided by one or more backside idler pulleys described in the present disclosure.

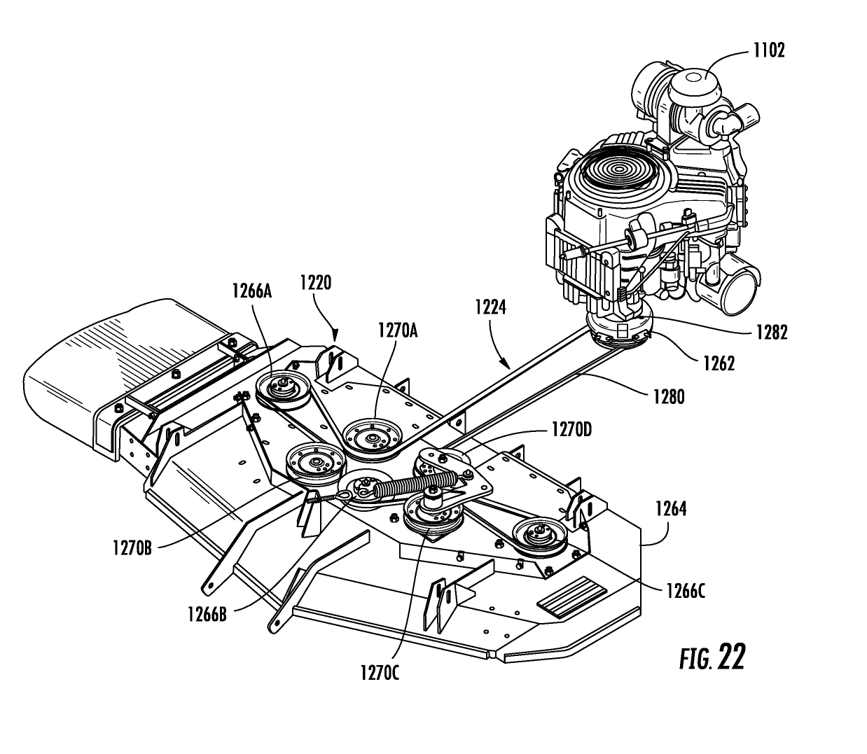

FIG. 22 illustrates mower deck 1220 and pulley arrangement 1224, one example of mower deck assembly 1120 and pulley arrangement 1124. Mower deck assembly 1220 comprises deck 1264 and rotatably driven mowing blades 1122 (one of which is shown in FIG. 21). Deck 1264 comprises a support structure that supports portions of pulley arrangement 1224. In the example illustrated, deck 1264 further serves as a shield about mower blades 1122 and as the discharge guide for directing the discharge of the vegetation cut by the mower. In the example illustrated, deck 1264 extends about and supports three individual rotationally driven implements in the form of cutting blades. In other implementations, deck 1264 may support a single driven implement, such as a single cutting blade or other combinations of multiple driven implements, such as multiple cutting blades.

Pulley arrangement 1224 comprises drive pulley 1262, deck 1264, driven pulleys 1266A, 1266B, 1266C (collectively referred to as driven pulleys 1266) and belt 1280. Drive pulley 1262 comprises a pulley that is operably coupled to power takeoff 1282 and that engages belt 1280. Pulley 1262 transmits torque from crankshaft 1282 to belt 1280. Pulley 1262 receives a front side of belt 1280.

Driven pulleys 1266 comprise pulleys rotatably supported by deck 1264 that are engaged by belt 1280. Driven pulleys 1266 are operably coupled to corresponding rotationally driven mower blades 1122. In the example illustrated, each driven pulley 1266 includes an internal groove that receives a front side of belt 1280.

Backside idler pulleys 1270 comprise pulleys rotatably supported by deck 1264 that are engaged by belt 1280. Backside idler pulleys 1270 are not coupled to any driven elements or implements, but guide and redirect belt 1280 between and into engagement with the various driven pulleys 166. Each of backside idler pulleys 1270 may have the configuration of backside idler pulley 20, 320, 420, 520, 620, 720, 820 or 920 described above.

Belt 1280 is similar to belt 53 described above and comprises an elongate continuous loop of a flexible material. Belt 1280 wraps about drive pulley 1262 and is guided by idler pulleys 1270 so as to wrap about and against each of driven pulleys 1266. The backside of belt 1280 contact and engages the floor 28 of each of backside idler pulleys 1270. Belt 1280 transmits torque from torque source 1262 to each of the driven pulleys 1266 and corresponding rotationally driven mower blades 1122.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements.

What is claimed is:

1. A backside idler pulley comprising:
a first member forming a first side wall of a circumferential groove of the backside idler pulley and forming a first floor support;
a second member, formed separately from the first member, and forming a second side wall, opposite the first side wall, of the circumferential groove of the backside idler pulley and forming a second floor support; and
a continuous layer between the first side wall and the second side wall, the continuous layer forming a floor of the groove, and supported by the first floor support and the second floor support.

2. The backside idler pulley of claim 1, wherein the continuous layer comprises an endless belt supported by the first member and the second member between the first side wall and the second side wall.

3. The backside idler pulley of claim 1, wherein the continuous layer comprises a metal band supported by the first member and the second member between the first side wall and the second side wall.

4. The backside idler pulley of claim 1, wherein the first floor support and the second floor support abut along a circumferential seam between the first side wall and the second side wall and wherein the continuous layer extends across the seam.

5. The backside idler pulley of claim 4, wherein the continuous layer comprises a coating filling the seam and extending across the seam to form a smooth surface between the first side wall and the second side wall.

6. The backside idler pulley of claim 4, wherein the continuous layer comprises a tape secured to the first member and the second member across the seam.

7. The backside idler pulley of claim 4, wherein the continuous layer comprises an endless belt.

8. The backside idler pulley of claim 7, wherein the endless belt is elastomeric and is stretched about a rotational axis of the pulley.

9. The backside idler pulley of claim 4, wherein the continuous layer comprises a metal band.

10. The backside idler pulley of claim 1, wherein the first floor support and the second floor support are separated in a direction along a rotational axis of the pulley and wherein the continuous layer comprises a band bridging between the first floor support and the second floor support while forming a floor of the groove.

11. The backside idler pulley of claim 1, wherein the continuous layer has a width of at least 50% of the spacing between the first side wall and the second sidewall.

12. The backside idler pulley of claim 1, wherein the floor is perpendicular to the first side wall and the second sidewall.

13. The backside idler pulley of claim 1 further comprising at least one retention groove in at least one of the first side wall and the second sidewall, wherein the continuous layer is received within the at least one retention groove.

14. The backside idler pulley of claim 1, wherein the continuous layer has a U-shaped cross-section.

15. The backside idler pulley of claim 1 further comprising a protuberance projecting above the first floor support or the second floor support, wherein the continuous layer extends over and receives the protuberance.

16. The backside idler pulley of claim 16, wherein the continuous layer comprises a preformed cavity receiving the protuberance.

17. The backside idler pulley of claim 16, wherein the continuous layer is compressible to deform about the protuberance.

18. A mower comprising:
a prime mover having a power takeoff;
a deck;
a cutting blade supported by the deck;
a drive belt; and
a pulley arrangement configured to direct the drive belt from the power takeoff of the prime mover to at least one drive pulley connected to the cutting blade, wherein the at least one drive pulley engages a front side of the drive belt and wherein the pulley arrangement comprises a backside idler pulley, the backside idler pulley comprising:
a first member forming a first side wall of a circumferential groove of the backside idler pulley and a first floor support;
a second member, formed separately from the first member, and forming a second side wall, opposite the first side wall, of the circumferential groove of the backside idler pulley and a second floor support; and
a continuous layer between the first side wall and the second side wall, the continuous layer forming a floor of the groove and supported by the first floor support and the second floor support, wherein the floor is in engagement with a backside of the drive belt.

19. A method comprising:
connecting two separate members to form first and second opposing side walls of a backside idler pulley and first and second floor supports; and
providing a continuous layer between the first and second opposing side walls over the first and second floor supports, the continuous layer forming a floor of a circumferential groove of the backside idler pulley.

20. The method of claim 19, wherein providing the continuous layer between the first and second opposing side walls comprises positioning an endless belt between the first and second opposing side walls, the belt having a face forming the floor of the circumferential groove of the backside idler pulley.
